(19) United States
(12) Patent Application Publication
(10) Pub. No.: US 2025/0104126 A1
(43) Pub. Date: Mar. 27, 2025

(54) Intelligent Spatial Mapping and Navigation System for Item Location

(71) Applicant: Donald Shattuck, Castle Rock, CO (US)

(72) Inventor: Donald Shattuck, Castle Rock, CO (US)

(21) Appl. No.: 18/891,388

(22) Filed: Sep. 20, 2024

Related U.S. Application Data
(60) Provisional application No. 63/539,944, filed on Sep. 22, 2023.

(51) Int. Cl. G06Q 30/0601

(52) U.S. Cl. CPC G06Q 30/0627

(57) ABSTRACT

The invention relates to systems and methods for generating digital representations of spaces and assisting visitors in navigating and locating items within those spaces. It comprises mapping an area using advanced camera and LIDAR technology, creating a detailed 3D model, and associating geotags with specific items or locations. The system utilizes interactive kiosks with digital displays, allowing visitors to view maps, search for items, and receive personalized directions. Additionally, the invention enables visitors to access the map and navigation information on their personal devices through QR code scanning. This technology enhances user experience in various environments such as retail stores, museums, and columbariums.

### CROSS-REFERENCE TO RELATED APPLICATIONS

This application claims the benefit of U.S. Provisional Patent Application 63/539,944 filed on Sep. 22, 2023, which is hereby incorporated by reference in its entirety.

### BACKGROUND OF THE INVENTION

The evaluation of interior and exterior spaces and generation of three-dimensional digital representations corresponding to such spaces remains commonplace. Companies such as Matterport have created 360-degree cameras and related tools to capture images of spaces, primarily with real estate sales applications in mind. Such tools have been utilized to generate a representation and/or map of a space. Exemplary tools and related aspects are described in U.S. Pat. Nos. 10,102,639; 11,677,920; 10,129,985; 10,540,054; 10,127,722; 11,682,103; and 8,879,828, and U.S. patent application Ser. No. 17/744,539 filed on May 13, 2022; each of which are incorporated by reference in their entirety.

A drawback of such systems is that they are directed exclusively toward commercial applications. It remains to be desired to have a system or device that allows for scanning of a space for consumer applications and more particularly tailored for consumer interaction. The previously created tools have not been configured to provide capability to detect an item and provide a map to that item for consumer use.

A persistent challenge presently faced by consumers remains associated with the difficulty of locating items within large interior spaces. Major “box store” retailers such as Home Depot, Walmart and Costco stock a variety of goods for consumers to physically locate in store prior to making a purchase. However, the sheer volume of products offered by such retailers, and the massive size of the stores that house them, causes difficulty for consumers when attempting to locate and purchase such items. Similarly, large museums often have numerous exhibits and sub-exhibits that museum-goers (especially those unfamiliar with the space) may have difficulty in locating. Likewise, those wishing to visit a location of cremains within a columbarium often have difficulty finding that location given the numerous other cremains housed.

While mapping tools have provided great advances toward the creation of a model of a space, the depiction of the map to a user unfamiliar with those tools or complex modeling software remains elusive. In particular, associating an item with a location within a space depicted by such tools remains a problem to be solved. A problem remaining to be solved therefore is a better mechanism to assist non-professionals in locating an item among many items within a large and/or unfamiliar space.

### SUMMARY OF THE INVENTION

The present invention relates to a system for generating a three-dimensional digital representation of a space, locating items within the space, and displaying a map of the space featuring the items to a layperson user. This system aims to make complex spaces more accessible to visitors unfamiliar with traditional technical mapping systems, thereby increasing the likelihood of locating specific items within the mapped space.

Key aspects of the preferred embodiment include: Systems and methods for generating and displaying a map of a space; Generation and storage of an associated three-dimensional digital model of the space; Correlation of locations to certain items within the space, optionally via geotags physically placed near each item; A kiosk or fixed-location user interface display means located at a known position within the space to depict the map via the three-dimensional digital model; A means to transfer the map viewed on the kiosk or fixed user interface display to a smartphone or tablet device carried by the visitor; and Functionalities associated with the map as viewed on the tablet or fixed-location user interface display to locate an item via text search or image search

The invention in an embodiment also comprises a method of mapping a space with designated locations for items that visitors may wish to find. The resulting visualization of the space, either in three-dimensional or top-down format, enables visitors to reduce the time required to locate desired items within the space.

This system is designed to address challenges faced by consumers in various environments, such as locating products in large retail stores, finding exhibits in museums, or locating cremains in columbariums. By providing an intuitive and accessible mapping solution, the invention aims to improve visitor experiences and efficiency in navigating complex spaces.

### BRIEF DESCRIPTION OF THE DRAWINGS

FIG. 1 depicts the layout of a space, optionally a store, comprising a plurality of geotags, aisles and shelves in an embodiment.

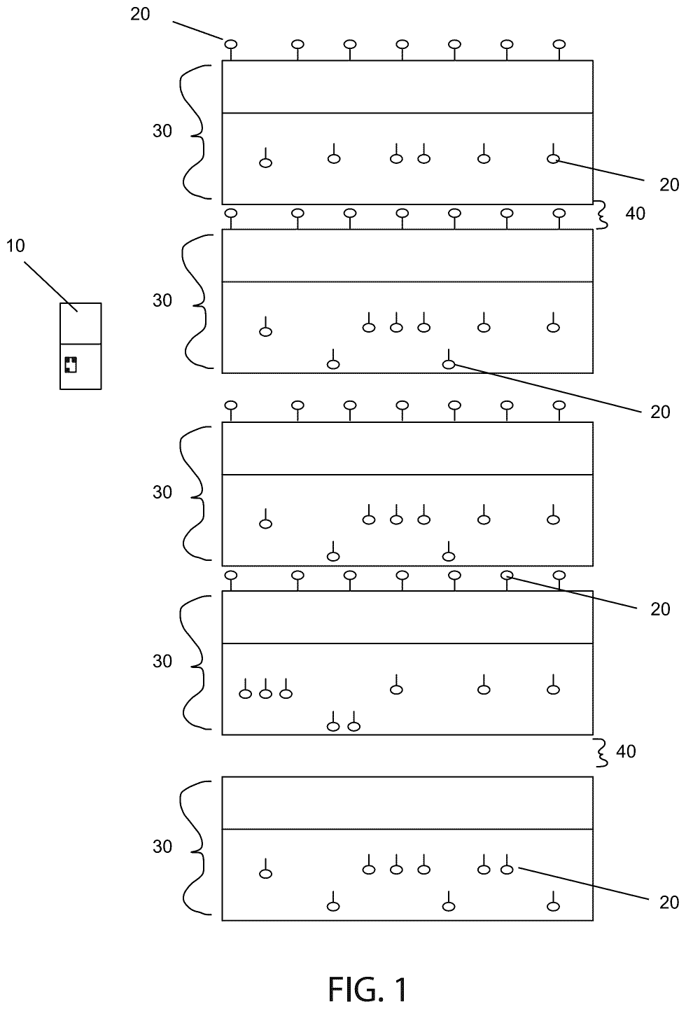

FIG. 2 depicts an embodiment of the screen of a kiosk comprising a presentation of the map of a space, a search function, and a QR code in an embodiment.

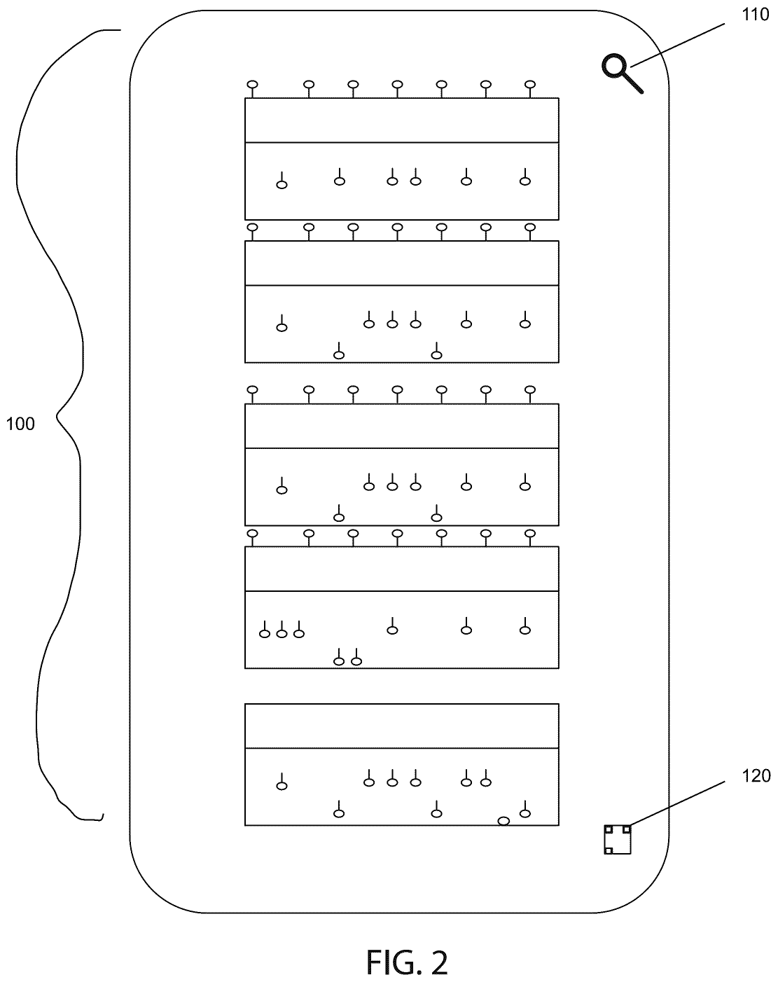

FIG. 3 depicts an embodiment of the screen of a kiosk comprising a presentation of an item associated with a geotag via a popup indicator and its location within the map of a space.

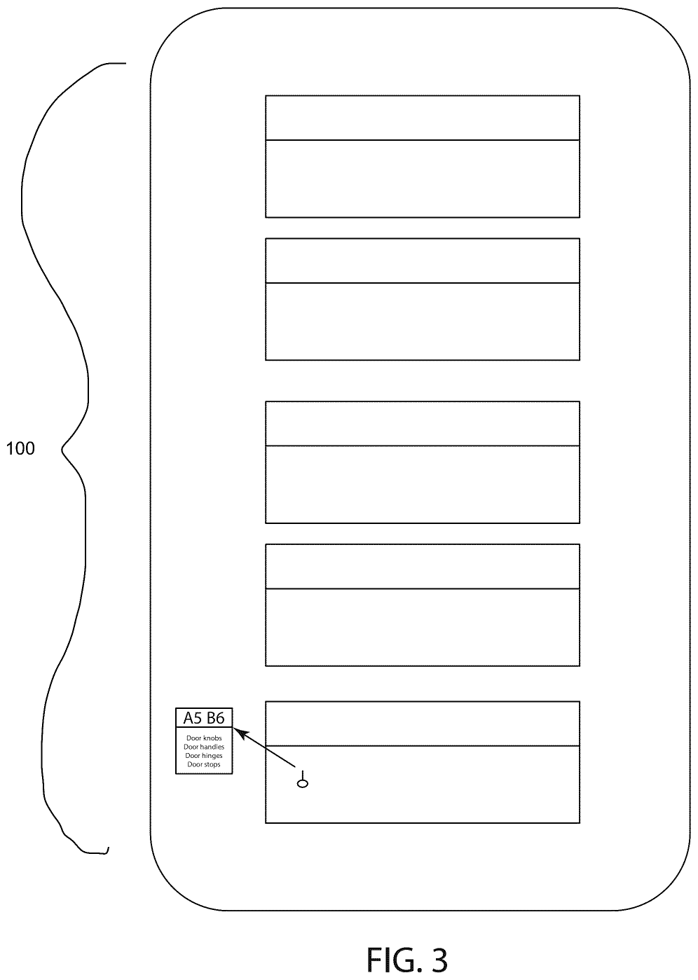

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Determining the location of an item within an unfamiliar and/or large space by a visitor may require assistance. Assistance may be manually provided by persons and/or staff more familiar with the space, however sometimes such resources are limited. In particular, discovering products at a large retail outlet may represent a daunting and time-consuming task that is inefficient for a visitor who is a consumer. Identifying the location of an exhibit in a large and unfamiliar museum may pose a challenge, particularly when children are in tow and museum staff are disposed with other museum visitors. Likewise, discovering the location of cremains of a loved one by a visitor at a columbarium may represent a challenge for a visitor, particularly if the cremains are of a loved one leading to an emotionally challenging situation.

Disclosed is an intelligent platform that generates mappings primarily for visitors of a large and/or unfamiliar space that reduces or eliminates the difficulty associated with finding locations within the space. The disclosed system can adapt with the changing location of discrete items by associating and disassociating geotags 20 with the discrete items. The disclosed system allows for colocation of each geotag 20 proximal to the item that it is associated with within the corresponding 3D model. In various embodiments the mapping of a space takes place. In one example, the mapping takes place by photographing a physical space with a camera optionally further comprising a LIDAR system. Via further computer processing, the data collected from the camera optionally further comprising a LIDAR system, and more specifically the location data, is aggregated together to create a representation of dimensions of the space. Via further computer processing, this representation of dimensions of the space is translated to a 3D model in an embodiment. In an embodiment, the location of the geotag 20 associated with a discrete item, or a label associated with a section of the space, is then designated within the model representing the space by a user of a related computer application via an associated user interface depicting the model. Optionally, the geotags 20 and labels are then depicted on a map to later be displayed to the visitor of a space. In an embodiment, each geotag 20 corresponds to a class of items (i.e. “nails” or “screws”) and not to a specific individual item.

The disclosed system may depict a pathway from the location of a visitor within a space to the location of an item the visitor wishes to visit in the space. The pathway may be depicted on a two-dimensional or three-dimensional map displayed to a visitor. The map may be displayed to the visitor upon a smartphone or tablet device held by the user, so that the user may carry the map during the journey to the item or location, and/or on a kiosk 10 encountered by the visitor. A two-dimensional depiction of the map and optionally the pathway from a specific location visited by the visitor (i.e. the location of the kiosk 10) to the location of the item desired to be found by the visitor may be printed on paper by a printer located proximal to the kiosk 10 so that the visitor may carry a paper version of the map during the visitor's journey to the item. In various embodiments, multiple items and multiple pathways may be depicted on the same map.

An embodiment of the system comprises a 360 degree camera. In accordance with such embodiment, the mapping of the space takes place utilizing the 360 degree camera. This type of camera is capable of capturing a complete spherical view of the surrounding environment in a single shot or through a series of shots that are stitched together. The process typically involves positioning the camera at various points throughout the space to be mapped. At each position, the camera rotates to capture images covering a full 360-degree horizontal view and often a 180-degree vertical view as well. These comprehensive images are then processed and combined to create a detailed, immersive representation of the entire space.

The use of a 360 degree camera allows for efficient and accurate capture of spatial data, including the layout, dimensions, and features of the area being mapped. This method is particularly effective for creating virtual tours, interactive floor plans, or detailed digital models of interior and exterior spaces, providing a foundation for further analysis and visualization of the mapped area.

Several specific cameras are appropriate for embodiments of this invention. Examples of such cameras include:

The Matterport Pro3 Camera is a professional-grade 3D capture device specifically designed for creating high-quality virtual tours and 3D models of spaces. It combines 360-degree imagery with depth sensing technology for accurate spatial mapping.

The Matterport Pro2 3D Camera, an earlier model in the Matterport line, is also well-suited for creating detailed 3D scans of interior spaces.

The Ricoh Theta Z1 is a high-end 360-degree camera that captures high-resolution spherical images and videos. It's compact and easy to use, making it suitable for both professional and consumer applications.

The Ricoh Theta X and Ricoh Theta V are other models in the Ricoh Theta line, offering various features and price points for 360-degree image capture.

The Insta360 X3 and Insta360 One cameras are known for their versatility and high-quality 360-degree image capture. They're popular choices for both professional and consumer use.

The Leica BLK360 is a professional-grade 3D imaging laser scanner that could be considered in accordance with an embodiment.

These and other cameras, when used in conjunction with appropriate software systems, are capable of capturing both image and coordinate data associated with a space. The data can then be processed and translated into a detailed map or 3D model of the area, which forms the basis for the various functionalities of an embodiment, such as item location and navigation within the mapped space.

In an embodiment, the system comprises a lidar camera. In accordance with such embodiment, the mapping of the space is created by utilizing a lidar camera. Lidar, which stands for Light Detection and Ranging, is a remote sensing technology that uses laser light to measure distances and create detailed 3D maps of an environment. A lidar camera emits laser pulses and measures the time it takes for the light to bounce back, allowing it to accurately determine the distance to objects and surfaces in the space.

When used for mapping a space, a lidar camera is typically moved through the area, continuously scanning and collecting data points. These data points form a point cloud that represents the three-dimensional structure of the space. The lidar camera can capture highly accurate measurements of the space's dimensions, including the layout of rooms, the position of walls, doors, and windows, and even smaller details like furniture or fixtures.

The use of a lidar camera for mapping offers several advantages. It provides highly accurate and detailed spatial data, which is particularly useful for creating precise 3D models of complex environments. Lidar technology can work in low-light conditions and can often penetrate through small gaps to capture data that might be missed by traditional cameras.

In the context of this invention, a lidar camera could be used in conjunction with or as an alternative to the 360-degree cameras mentioned earlier. For example, the Leica BLK360, while primarily known as a 3D imaging laser scanner, incorporates lidar technology for precise spatial mapping. The data collected by a lidar camera can be processed and combined with other imaging data to create a comprehensive and accurate digital representation of the mapped space. This detailed mapping is crucial for the various functionalities described in the invention, such as precise item location and navigation within the mapped area.

In some embodiments, the lidar camera is configured to capture measurements to objects photographed within a space. This configuration allows the lidar camera to not only capture visual data but also precise spatial information about the objects and surfaces in the environment. The lidar camera emits laser pulses that bounce off objects in the space and return to the camera's sensor. By measuring the time it takes for these pulses to return, the camera can calculate the exact distance to each point in the space. This results in a highly accurate three-dimensional representation of the space, including the size, shape, and position of objects within it. The measurements captured by the lidar camera can be incredibly precise, often down to millimeter accuracy, providing detailed information about the dimensions and spatial relationships of objects in the photographed area. This level of detail is particularly useful for creating accurate 3D models, determining exact locations of items within a space, and enabling precise navigation and mapping functionalities as described in the invention.

In an embodiment, the camera utilized for the mapping of the space is configured to or otherwise utilized in combination with computer processing configured to transform the two-dimensional imagery captured by the camera into a three-dimensional digital model, and the system comprises such computer processing in accordance with such embodiment.

Embodiments of the invention comprise software algorithms that analyze the 2D images captured by the camera and extract depth information to create a 3D representation of the space. These algorithms in accordance with exemplary embodiments employ techniques such as Structure from Motion (SfM) and Multi-View Stereo (MVS) to reconstruct 3D geometry from multiple 2D images.

Structure from Motion algorithms work by identifying and matching distinctive features across multiple images. These features could be corners, edges, or other visually distinct points. By tracking how these features move across different images, the algorithm can infer the 3D structure of the scene and the camera positions.

Multi-View Stereo algorithms then use this initial 3D structure to create a dense 3D reconstruction. They do this by finding corresponding pixels across multiple images and using triangulation to determine their 3D positions.

The computer processing may use techniques such as photogrammetry, which involves analyzing multiple overlapping 2D images to determine the 3D geometry of objects and surfaces in the space. Photogrammetry software, which in embodiments of the invention comprise examples such as Agisoft Metashape or Pix4D, uses these SfM and MVS algorithms to create detailed 3D models from sets of 2D images.

Additionally, in an embodiment the camera system includes depth-sensing capabilities (such as those found in some of the mentioned devices like the Matterport Pro3), wherein this depth data can be integrated with the 2D imagery to enhance the accuracy of the 3D model. For example, the Matterport Pro3 camera as an aspect of a system embodiment uses infrared depth sensors alongside its RGB cameras. The depth data provides direct measurements of distances to objects in the scene, which can be used to refine and validate the 3D reconstruction from the 2D images.

The integration of depth data typically involves aligning the depth measurements with the corresponding pixels in the 2D images. This process, known as sensor fusion, combines the high-resolution color information from the 2D images with the accurate depth measurements to create a more precise and detailed 3D model.

Machine learning algorithms, particularly convolutional neural networks (CNNs), are increasingly being used to improve various aspects of this 3D reconstruction process. For example, CNNs can be trained to better identify and match features across images, or to predict depth from single images, further enhancing the accuracy and robustness of the 3D reconstruction.

The resulting three-dimensional digital model provides a comprehensive representation of the mapped space, including accurate spatial relationships, dimensions, and textures of objects and surfaces within the area. This 3D model serves as the foundation for various functionalities described in the invention, such as precise item location, navigation, and interactive visualization of the mapped space.

The resulting three-dimensional digital model in accordance with such embodiment provides a comprehensive representation of the mapped space, including accurate spatial relationships, dimensions, and textures of objects and surfaces within the area. This 3D model serves as the foundation for various functionalities described in the invention, such as precise item location, navigation, and interactive visualization of the mapped space.

In some embodiments, the computer processing is performed using a trained machine learning algorithm. Machine learning algorithms, particularly convolutional neural networks (CNNs), are increasingly being utilized to enhance various aspects of the 3D reconstruction process. These algorithms can be trained to improve the identification and matching of features across images, or to predict depth from single images, thereby increasing the accuracy and robustness of the 3D reconstruction.

For example, CNNs can be trained on large datasets of images and corresponding 3D models to learn how to extract relevant features and patterns that are indicative of 3D structure. Once trained, these algorithms can be applied to new images to assist in the reconstruction process. They can help in tasks such as feature detection, feature matching, depth estimation, and even in refining the final 3D model.

By incorporating trained machine learning algorithms into the computer processing pipeline, the system can potentially produce more accurate, detailed, and robust 3D digital models of the mapped space, which in turn supports the various functionalities described in the invention, such as precise item location and navigation.

In some embodiments, a three-dimensional visualization generated following the mapping of the space is provided to the visitor as a visualization depicted on a display physically fixed at a location within the space. This visualization in an embodiment is presented on an interactive digital display that forms part of a kiosk 10 located at a specific point within or near the mapped area. The kiosk 10 serves as a fixed reference point where visitors can access and interact with the three-dimensional model of the space.

The kiosk 10 may take various forms to suit the environment in which it is placed. It could be a standup kiosk, mounted onto the floor for stability and ease of access. Alternatively, it might be mounted to a table, countertop, or desk, depending on the specific needs of the space and its visitors.

This fixed display allows visitors to view and interact with the three-dimensional visualization of the mapped space without needing to use their own devices. The kiosk's display can show various views of the 3D model, such as a dollhouse view, floor plan view, or digital twin view, providing visitors with comprehensive spatial information.

The visualization on the kiosk's 10 display can be used to help visitors locate specific items or areas within the space. Visitors can interact with the display to search for items, view their locations within the 3D model, and receive directions from their current location to the desired item or area. This functionality enhances the visitor's ability to navigate the space efficiently, particularly in large or complex environments such as stores, museums, or columbariums.

In some embodiments, a two-dimensional visualization of the map is printed onto paper for the visitor via a printer located proximal to the kiosk 10. This printed map provides a tangible, portable reference that visitors can carry with them as they navigate the space. The printer, being located near the kiosk, allows for convenient and immediate access to the printed map after interacting with the kiosk's display. This feature is particularly useful for visitors who prefer a physical map or for spaces where electronic devices may not be practical or allowed. The printed map likely includes key information such as the layout of the space, locations of important items or areas, and potentially a highlighted route from the kiosk to a specific destination chosen by the visitor. This printed visualization complements the digital display on the kiosk, offering an alternative or additional means for visitors to orient themselves and locate items within the mapped space.

In some embodiments, a three-dimensional digital visualization generated following the mapping of the space is provided to the visitor on the display of a smartphone or tablet device carried by the visitor. This feature allows visitors to access and interact with the 3D model of the mapped space on their personal mobile devices, providing a portable and personalized navigation tool. The visualization can be transferred to the visitor's device through various means, such as scanning a QR code displayed on the kiosk or through a wireless transfer method.

The three-dimensional digital visualization on the smartphone or tablet can offer similar functionalities to those available on the fixed kiosk display. Visitors can view different perspectives of the mapped space, such as dollhouse views, floor plan views, or digital twin views. They can interact with the model to search for specific items, view their locations within the space, and receive personalized navigation instructions from their current position to desired destinations.

This mobile accessibility enhances the visitor's ability to navigate the space independently, particularly in large or complex environments. It allows visitors to carry the map with them as they move through the space, providing real-time guidance and information about their surroundings. The smartphone or tablet visualization can be especially useful in scenarios where visitors need to locate multiple items or navigate to several locations within the mapped area.

Another aspect of the present disclosure provides a method for associating the location of a discrete item within a mapped space. In some embodiments the location of the discrete item is manually associated by a person overseeing or performing the mapping process. In some embodiments of the invention, the location of a discrete item is associated with a geotag 20 placed proximally to the item within the space. In various embodiments, the placement of the geotags 20 occurs digitally. In various embodiments, each of the geotags 20 is associated with a location, an item, and/or the location of an item within a 3D model.

Various embodiments incorporate labels within the model. As an example, each of the labels is placed and is visible as a label within a model corresponding to a space depicting a dollhouse view. As an example, each of the labels is placed and is visible as a label within a model corresponding to a space depicting a floorplan view. In an embodiment, a label corresponds to a section of a space. In the example of a model depicting a large home improvement store, a label might correspond to the section for tools, whereas a separate label might correspond to the section for electrical goods. In various examples, each section corresponding to a label within a model may comprise one or more items, each optionally corresponding to a geotag 20.

In some embodiments of the invention, a discrete geotag 20 detectable by the camera or its accessories during the geomapping process is associated with a discrete item, wherein the location of the geotag 20 in association is later displayed in association with a depiction of the item within a map to a visitor to the space. This approach allows for precise item localization within the mapped area. The geotag 20 serves as a marker that can be identified during the mapping process, enabling the system to accurately pinpoint the location of specific items within the space.

The geotags 20 are designed to be detectable by the mapping mechanism, which may include cameras with various capabilities such as 360-degree imaging or lidar technology. During the mapping process, these geotags 20 are captured along with other spatial data, allowing the system to associate specific items with their exact locations within the three-dimensional model of the space.

In an exemplary embodiment, each geotag may be located directly on a shelf 30 containing the item or located within an aisle 40 located proximal to the item. This placement strategy ensures that the geotag 20 is closely associated with the item it represents, facilitating accurate location information. For items on shelves, placing the geotag directly on the shelf 30 provides a precise reference point. For larger items or those not confined to shelves, placing the geotag within the nearby aisle 40 allows for flexibility while still maintaining proximity to the item.

Once the mapping process is complete and the three-dimensional digital model is generated, the location of each geotag 20 is incorporated into the model. When a visitor interacts with the system, either through a fixed kiosk or a mobile device, the map displayed to them includes the depiction of items associated with these geotags. This allows visitors to easily locate specific items within the space, enhancing their navigation experience and efficiency in finding desired objects or locations.

In some embodiments of the invention, a unique QR code 120 is associated with each space. This QR code 120 serves as a digital identifier for the specific mapped area, allowing visitors to easily access and interact with the three-dimensional digital model of the space on their personal devices. When scanned by a visitor using a smartphone or tablet, the QR code 120 triggers the download of the model and any necessary software to display it on the visitor's device.

The QR code 120 can be displayed prominently on the kiosk 10 or at strategic locations within the mapped space. This feature enables visitors to quickly obtain a personalized, portable version of the map, enhancing their ability to navigate the space independently. By associating a unique QR code with each space, the system ensures that visitors access the correct and most up-to-date model for their specific location, which is particularly useful in large facilities with multiple mapped areas or in locations that undergo frequent changes.

In some embodiments of the invention, a visitor to the space can utilize a smartphone or tablet device to scan the QR code 120 to view a three-dimensional map or two-dimensional map, or a portion of a three-dimensional or two-dimensional map, depicting at least the path from the visitor's location at the time the QR code 120 is scanned to the item associated with the QR code 120. This feature enhances the visitor's ability to navigate the space efficiently and locate specific items of interest.

When a visitor scans the QR code 120 using their smartphone or tablet in an embodiment, it triggers the download of the appropriate map model and any necessary software to display it on their device. The system then uses the visitor's current location (determined by the location of the scanned QR code) as a starting point to generate a customized path to the desired item.

The map displayed on the visitor's device can be either a full three-dimensional visualization of the space or a simplified two-dimensional representation, depending on the specific implementation and the visitor's preference. In some cases, the system may display only a portion of the map, focusing on the relevant area between the visitor's current location and the target item to simplify navigation.

This functionality allows visitors as users in accordance with embodiments to have a personalized, portable navigation tool that guides them directly to their desired item within the mapped space. It's particularly useful in large or complex environments such as stores, museums, or columbariums, where finding specific items or locations can be challenging.

In some embodiments of the invention, a word search form is depicted to a visitor on a display of a kiosk 10. In some embodiments, following the visitor's input of words corresponding to an item, the kiosk 10 is configured to display the item and provide to the visitor a three-dimensional map or two-dimensional map, or a portion of a three-dimensional or two-dimensional map, depicting at least the path from the visitor's location at the time the words are input by the user to the item, either on the kiosk 10 itself, a smartphone or tablet held by the visitor, or both.

The preferred embodiment of the system is designed to generate and depict a map of an area (also referred to interchangeably as a “space”) to a visitor. This system associates the coordinates or other location information of one or more items within the area with the map. The map is then provided to a visitor via an interactive digital display 100 or as a printed paper for use while in the area.

The system comprises several key components, starting with the kiosk 10. This is a small structure strategically located in or near the mapped area, incorporating one or more interactive display screens. The kiosk 10 serves as a central hub where visitors can access information about items and their locations within the mapped space. It is typically placed at a fixed, predetermined location within or near the mapped area to ensure consistent accessibility. The kiosk 10 is equipped with multiple features to enhance user experience. It includes a printer located nearby, allowing for the production of physical maps that visitors can carry with them. Additionally, the kiosk 10 is outfitted with wireless communication capabilities such as Bluetooth and Wi-Fi, enabling it to connect seamlessly with visitors' smartphones or tablets. This connectivity allows for the transfer of map data and navigation information directly to personal devices. The centerpiece of the kiosk 10 is its interactive digital display 100, which may be a touchscreen or non-touch display, providing an intuitive interface for visitors to interact with the mapping system.

Geotags 20 form another crucial component of the system. These are digital markers associated with specific locations or items within the mapped space. Each geotag 20 corresponds to a discrete object in the space represented by the model. For example, in a large store, each geotag 20 would be associated with a location depicted within the model along an aisle proximal to the item the geotag 20 corresponds with. Geotags 20 can be added, edited, or repositioned within the model using a computer application, providing flexibility in managing the mapped space. Users can add geotags 20 via a user interface by selecting the precise location within the mapped area where the tag is desired to be added, optionally in association with an item located within the space. The location of each tag, referred to as an anchor point, can be adjusted as needed. Geotags 20 may contain various data about the associated item, including title, description, image, pricing, and other relevant information, enhancing the depth of information available to visitors.

The mapping mechanism is a vital component that captures the spatial data of the area. It typically consists of a camera, often equipped with lidar technology for precise distance measurements. Specific examples of mapping mechanisms include the Matterport Pro3 Camera, Matterport Pro2 3D Camera, Leica BLK360 system, Ricoh Theta series, Insta360 series, and other 360-degree spherical cameras. These devices, along with associated software systems, are capable of capturing detailed image and coordinate data of the space. The choice of mapping mechanism can depend on the specific requirements of the space being mapped, such as size, complexity, and desired level of detail.

The master map is the foundational representation of the captured area, generated after the initial mapping process. It provides a comprehensive view of the space without any item or geotag 20 information, serving as a blank canvas upon which additional information can be layered. The master map can be created in accordance with RICS (Royal Institution of Chartered Surveyors) standards, ensuring professional-grade accuracy and consistency. In many cases, the master map may be based on a Matterport floor plan, leveraging the detailed spatial data captured by Matterport systems.

The three-dimensional model is a detailed digital representation of the mapped space, offering a immersive and accurate depiction of the area. This model can be translated into a two-dimensional view through computer processing, providing flexibility in how the space is presented to users. The model is typically stored in various file formats such as .svg, .obj, .stl, .3ds, or .iges, ensuring compatibility with a wide range of systems and devices. This versatility allows the model to be used across different platforms and applications, from kiosk displays to mobile devices.

The interactive digital display 100 serves as the primary interface between the system and its users. It can be integrated into the kiosk 10 or exist as a separate device, such as a visitor's smartphone or tablet. When part of the kiosk 10, it's linked to a sophisticated computer system that manages the display of information, operates applications, and performs processing tasks related to showing 3D and 2D maps. The display provides an intuitive and responsive interface for visitors to explore the mapped space, search for items, and plan their routes.

The system is designed to present information about various types of items, adapting to different use cases and environments. In a large store setting, it helps consumers locate specific products within the store, potentially reducing frustration and improving the shopping experience. In a columbarium, the system can guide visitors to the specific locations of cremains, providing a respectful and efficient way to navigate these sensitive spaces. In a museum context, the system assists visitors in finding particular exhibits or galleries, enhancing the educational and cultural experience. This versatility demonstrates the system's ability to improve navigation and item location across a wide range of complex spaces, ultimately enhancing visitor experiences and reducing the time and effort required to find desired locations or objects.

The method for capturing a digital representation of a space in accordance with an embodiment includes several key steps in accordance with various embodiments, comprising all or part of the following:

Mapping an area: This step involves utilizing a mapping mechanism, typically a camera equipped with or linked to a LIDAR system. The process begins by selecting an initial location and capturing 360-degree images. The camera rotates, stopping at intervals (e.g., every 90 degrees) to capture photos. Simultaneously, the LIDAR system collects location data of objects within the space, including shelves 30 and aisles 40. This process is repeated from multiple locations, moving the camera 5 to 20 feet depending on the openness of the space, to create a comprehensive representation of the area.

Assembling and transferring data: The images from the camera and LIDAR data are compiled and transferred for use in subsequent steps. A computer application may retrieve each 360-degree image, associate location data with it, and present it to the operator via a user interface, gradually building a more comprehensive map. This step ensures that all captured data, including the locations of shelves 30 and aisles 40, is accurately represented in the final model.

Storing the map: The collected data is stored in a format capable of being displayed as both three-dimensional and top-down views of the area. This involves translating the camera images and LIDAR data into a digital map through computer processing. The individual 360-degree images are combined into a single model, often using specialized software like the Matterport suite. The resulting map may be stored as one or more image files in various formats, including dollhouse view, floor plan view, and digital twin view. These views can depict the geotags 20 within the space, providing a comprehensive representation of the mapped area.

Correlating geotags: This step involves associating one or more geotags 20 with specific locations or items within the mapped area. These geotags 20 can be virtual and managed through a computer application. The process may involve using unique identifiers, QR codes 120, RFID tags, or LIDAR reflectivity to associate geotags 20 with physical locations or items. This step typically occurs after the initial mapping and may involve manual entry by a user through a computer application. Geotags 20 can be placed directly on shelves 30 containing items or within aisles 40 located proximal to the items.

Displaying the map: The map is presented on an interactive digital display 100 to visitors entering the area. This display may be part of a fixed kiosk 10, a smartphone, or a tablet. The map can include a list of items associated with geotags 20 and depictions of their locations within the area. The display process may involve retrieving item information from a separate database and using computer processing to depict items on the map, showing their relationships to shelves 30 and aisles 40.

Facilitating item selection: This step allows visitors to interact with the map display to select specific items. This can be done through touch screen interaction, mouse input, or keyboard entry for text searches using the search functionality 110. The system may also provide QR codes 120 that visitors can scan with their personal devices to access the map and associated information. When an item is selected, the display may show additional information in a popup form, and other items and geotags 20 may disappear from the display, focusing the visitor's attention on the selected item.

Delivering directions: The final step involves providing directions to the visitor from their current location to the selected item. These directions can be delivered in various forms, including a highlighted pathway on a 2D or 3D map displayed on the interactive digital display 100, sent to the visitor's personal device, or printed on paper. The directions may be triggered by the visitor scanning a QR code 120 or through other interactive means. The directions guide the visitor through the aisles 40 to the specific shelf 30 containing the desired item.

This method provides an approach in accordance with an embodiment of the invention to creating, managing, and utilizing digital representations of spaces utilizing elements of the system described herein, enabling efficient navigation and item location for visitors in various environments.

### EXAMPLES OF USE

### Example 1: Columbarium

Most churches and mortuaries have a columbarium. Some of these columbariums are quite large with over 1,000 cremains. Without the currently presented invention, a visitor, to find loved-one cremains, has to go to the office, interrupt the staff and then go to the appropriate location in the columbarium. In an exemplary use of the invention, the visitor could interact with the display of a standing kiosk 10 where the visitor can type in the loved-one's name to view the cremains as an item, and to receive a map both upon the display of the kiosk 10 and the display of the visitor's smartphone depicting the location of the cremains within the columbarium area upon a map presented on the display of the kiosk 10.

### Example 2: Museum

Visitors to a museum are generally not intimately familiar with the space. In association with an exemplary use of the invention, a visitor could enter the space of a museum where a kiosk 10 in association with an aspect of the invention is located. The visitor could interact with the display of the kiosk 10 to find where a specific artwork exhibit as an item is located within the museum gallery within the area of the museum. By scanning a QR code 120 displayed upon the display of the kiosk 10 by utilizing his or her smartphone, the visitor would wirelessly receive a three-dimensional map model of the museum space onto his or her smartphone, and utilize the map displayed upon the smartphone to directly travel to the artwork or exhibition as an item on the map, and in association with the item read or hear about the item that the visitor is visiting within the space upon the display of the smartphone.

### Example 3: Box Store

The scale of large “box stores” such as Home Depot, Walmart, or Costco often is intimidating for visitors to such areas. In an exemplary use of the invention, a visitor entering the area of a Home Depot store trying to find a single item such as a door stop may prove a daunting task. Instead, in association with aspects of the present invention, the visitor may alternatively utilize a kiosk 10 that has a Matterport model of the entire store, type in “door stop” by utilizing a keyboard communicatively linked to the interactive digital display 100 of the kiosk 10, and subsequently view mapping information upon the display of the kiosk 10 with information corresponding to the row and the bin number of where the door stop is located within the area of the Home Depot store. Typing in “door stop” will show you a picture from the model of the bin where the item is located. This patent would provide a solution to finding an item in a large store.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

I claim:

1. A system for generating and displaying a digital representation of a space, comprising:
a mapping mechanism configured to capture spatial data of an area;
a computer processor configured to generate a three-dimensional digital model of the area based on the captured spatial data;
one or more geotags associated with specific locations or items within the area;
a kiosk located within or proximal to the area, the kiosk comprising:
an interactive digital display;
a wireless communication module;
a computer system communicatively linked to the interactive digital display and the wireless communication module;
wherein the computer system is configured to:
display the three-dimensional digital model on the interactive digital display;
allow a user to select an item associated with a geotag;
generate directions from the kiosk to the selected item.

2. The system of claim 1, wherein the mapping mechanism comprises a camera equipped with a LIDAR system.

3. The system of claim 1, further comprising a printer communicatively linked to the kiosk, configured to print a two-dimensional representation of the directions.

4. The system of claim 1, wherein the wireless communication module is configured to transmit the three-dimensional digital model and directions to a user's mobile device.

5. The system of claim 1, wherein the interactive digital display is configured to display a QR code associated with the selected item, the QR code being scannable by a user's mobile device to receive the directions.

6. A method for generating and displaying a digital representation of a space, comprising:
mapping an area using a mapping mechanism to capture spatial data;
assembling and transferring the captured spatial data;
generating a three-dimensional digital model of the area based on the captured spatial data;
correlating one or more geotags with specific locations or items within the area;
displaying the three-dimensional digital model on an interactive digital display;
receiving a user selection of an item associated with a geotag;
generating directions from a current location to the selected item;
delivering the directions to the user.

7. The method of claim 6, wherein mapping the area comprises:
capturing 360-degree images at multiple locations within the area;
collecting LIDAR data of objects within the area simultaneously with capturing the 360-degree images.

8. The method of claim 6, wherein generating the three-dimensional digital model comprises combining multiple 360-degree images into a single model using computer processing.

9. The method of claim 6, wherein correlating the one or more geotags comprises manually entering geotag information through a computer application.

10. The method of claim 6, wherein delivering the directions comprises at least one of:
displaying a highlighted pathway on the three-dimensional digital model;
transmitting the directions to a user's mobile device;
printing the directions on paper.

11. A non-transitory computer-readable medium storing instructions that, when executed by a processor, cause the processor to perform a method for generating and displaying a digital representation of a space, the method comprising:
receiving spatial data of an area captured by a mapping mechanism;
generating a three-dimensional digital model of the area based on the received spatial data;
associating one or more geotags with specific locations or items within the three-dimensional digital model;
displaying the three-dimensional digital model on an interactive digital display;
receiving a user selection of an item associated with a geotag;
generating directions from a current location to the selected item;
providing the directions to the user.

12. The non-transitory computer-readable medium of claim 11, wherein the method further comprises generating a QR code associated with the selected item and the directions.

13. The non-transitory computer-readable medium of claim 11, wherein the method further comprises transmitting the three-dimensional digital model and the directions to a user's mobile device upon scanning of a QR code.

14. A system for assisting visitors in locating items within a mapped space, comprising:
a kiosk located at a fixed position within or proximal to the mapped space, the kiosk comprising:
an interactive digital display;
a wireless communication module;
a computer processor;
a non-transitory computer-readable storage medium storing instructions executable by the computer processor;
a three-dimensional digital model of the mapped space stored in the computer-readable storage medium;
a plurality of geotags, each geotag associated with a specific item and location within the three-dimensional digital model;
wherein the instructions, when executed by the computer processor, cause the kiosk to:
display the three-dimensional digital model on the interactive digital display;
receive a user selection of an item via the interactive digital display;
generate a route from the fixed position of the kiosk to the location of the selected item;
display the route on the three-dimensional digital model;
generate a QR code associated with the selected item and the route;
display the QR code on the interactive digital display.

15. The system of claim 14, further comprising a printer communicatively linked to the kiosk, wherein the instructions further cause the kiosk to print a two-dimensional representation of the route on the printer.

16. The system of claim 14, wherein the wireless communication module is configured to transmit the three-dimensional digital model and the route to a user's mobile device upon the user's mobile device scanning the QR code.

17. The system of claim 14, wherein the interactive digital display is a touchscreen, and the user selection of an item is received via touch input on the touchscreen.

18. The system of claim 14, wherein the kiosk further comprises a keyboard, and the instructions further cause the kiosk to:
display a search functionality on the interactive digital display;
receive text input via the keyboard;
search for items associated with the text input;
display search results on the interactive digital display.

19. The system of claim 14, wherein the three-dimensional digital model includes representations of shelves and aisles within the mapped space.

20. The system of claim 19, wherein each geotag is associated with a specific shelf or aisle location within the three-dimensional digital model.

21. The system of claim 14, wherein the instructions further cause the kiosk to display additional information about the selected item in a popup form on the interactive digital display.

22. The system of claim 14, wherein the instructions further cause the kiosk to remove display of non-selected items and their associated geotags from the three-dimensional digital model upon user selection of an item.

23. The system of claim 14, wherein the mapped space is selected from the group consisting of: a retail store, a museum, and a columbarium.
